(19) United States
(12) Patent Application Publication
(10) Pub. No.: US 2006/0130735 A1
(43) Pub. Date: Jun. 22, 2006

(54) Temperature sensor

(75) Inventor: Esteban M. Papp, Provincia de Cordoba (AR)

Correspondence Address: LADAS & PARRY, 26 WEST 61ST STREET, NEW YORK, NY, 10023, US

(73) Assignee: BEECH TREE SENSORS LLC

(21) Appl. No.: 11/013,933

(22) Filed: Dec. 16, 2004

(51) Int. Cl. G01K 1/02

(52) U.S. Cl. 116/219

(57) ABSTRACT

The present invention provides a temperature sensor comprising a transparent capsule which contains an assembly within the transparent capsule wherein the assembly comprises a fracturable capsule containing an aqueous solution which opens upon freezing of the aqueous liquid; and a substrate proximate to the fracturable capsule which exhibits a color change upon contact with the aqueous liquid.

### BACKGROUND OF THE INVENTION

1. Field of the Invention

The present invention relates to a temperature sensor for determining whether a certain temperature threshold has been breached, for example, for determining whether the sensor and any goods on which it is mounted have passed through a specific freezing point. Such sensors find use, for example, in determining whether frozen food has thawed and then been refrozen during its journey from a processing plant to the consumer or to determine whether fresh foods have been frozen and then thawed. The sensor of the present invention may also be used in determining whether stored laboratory specimens have passed through a specific freezing point.

2. Description of Related Art

The use of sensors for indicating whether a material has thawed and been refrozen is known. Such sensors use various techniques to reveal whether the material has passed through its freezing point.

U.S. Pat. No. 5,460,117 discloses a temperature indicator for refrigerated products comprising a combination of an entirely or partially transparent envelope containing a capsule filed with an aqueous solution, liquid at room temperature, and comprising a peripheral fracture point causing its separation into two parts when the volume of the material contained expands upon freezing. The capsule contains a compressed spring arranged such that when the capsule is broken along the fracture point, the spring remains compressed as long as the solution is in the solid state, but cleanly, visibly and irreversibly separates the two parts of the capsule from one another when the solution liquefies.

U.S. Pat. No. 5,254,473 discloses an indicator composition and process capable of changing color in response to its exposure above and below its baseline temperature and to the time of said exposure. The composition comprises a dispersion of either a binder comprising a reaction inert, neutral finely divided absorbent, in the presence of a reactant comprising a salt of an acid or an organic compound substituted by at least one moiety, which in ionic form, is an anion. The indicator further comprises at least one acid sensitive pH dye and as activator, at least one base.

Despite the temperature sensors described in the related art there remains a requirement for a low cost temperature sensor that can provide a permanent and clearly visible indication that a temperature threshold has been breached.

### BRIEF SUMMARY OF THE INVENTION

According to the present invention there is provided a temperature sensor comprising a transparent capsule which contains an assembly within the transparent capsule wherein the assemble comprises

a) a fracturable capsule containing an aqueous liquid which opens upon freezing of the aqueous liquid; and

b) a substrate proximate to the fracturable capsule which exhibits a color change upon contact with the aqueous liquid.

The assembly is capable of indicating whether the sensor and any goods on which it is mounted have passed through a specific freezing point temperature threshold. Upon freezing the aqueous liquid expands and opens or breaks the fracturable capsule. As the temperature is increased the aqueous liquid melts and contacts the substrate which exhibits a color change. Such color change may result either from staining by a stain present in the aqueous liquid or as a result of an interaction between the aqueous liquid and a component present in the substrate which causes a color change. Consequently even if the temperature returns to below the specific freezing point a permanent indication that the temperature threshold has at one time been breached is provided. This is particularly useful when the temperature sensor is attached to frozen foods such that the consumer can determine if the foods have been thawed and subsequently refrozen.

### DETAILED DESCRIPTION OF THE INVENTION

The temperature sensor of the present invention comprises a transparent capsule, which contains an assembly within the transparent capsule wherein the assembly comprises a fracturable capsule which contains an aqueous liquid. A substrate located proximate to the fracturable capsule exhibits a color change upon contact with the aqueous liquid.

The transparent capsule may be formed from any suitable transparent material e.g. glass but is preferably formed from a polymeric compound. Typically the transparent capsule is formed from polyethylene or polypropylene. Preferably the fracturable capsule is also transparent and may be formed from the same material as the transparent capsule. The transparent capsule usually has a volume of between 2-10 cm³, preferably between 4-8 cm³ and the fracturable capsule usually has a volume of between 1-10 cm³, preferably between 5-5 cm³.

The aqueous liquid preferably comprises a staining agent which is capable of staining the substrate. The staining agent is preferably a coloring agent and is preferably non toxic. The coloring agent may be any one listed in the Codex Alimetarius. Typically the coloring agent is selected from amaranth, azorbubine, ponceau, quinolene yellow, indigotine, erythrosine or tartrozine. Preferably the coloring agent is amaranth.

The fracturable capsule is usually substantially filled with the aqueous liquid.

The substrate is preferably a stainable substrate and is typically an absorbent substrate and is usually produced from paper, wood, cotton, cardboard and/or absorbent polymers. The substrate may also contain a component e.g. a staining agent that changes color upon contact with the aqueous liquid e.g. litmus.

When used herein the term “staining agent” and “stainable substrate” mean that when the two come into contact they interact in a way to produce a visible color change within the substrate.

The staining of the stainable substrate is an irreversible process which allows a person to view the substrate within the transparent capsule and know that at some time after the original freezing point the sensor had been increased to a temperature above the freezing point of the aqueous liquid contained in the fracturable capsule. The staining agent can be incorporated in the aqueous liquid or in the substrate so that it will change color when contacted by the aqueous liquid.

In a preferred embodiment of the present invention the aqueous liquid further comprises a fully water miscible liquid which affects the freezing point of the aqueous liquid.

The fully water miscible liquid usually has a freezing point lower than that of water and is typically an organic liquid such as an ether or an alcohol. Most preferably the fully water miscible liquid is an alcohol. Ethyl alcohol is particularly useful as a component of the aqueous liquid for this purpose.

The temperature at which the aqueous liquid melts depends on the proportion and the freezing point of the filly water miscible liquid in the aqueous liquid. The higher the percent of filly water miscible liquid in the aqueous liquid the lower the temperature at which the substance will freeze and melt.

Usually the fully water miscible liquid comprises between 0-50% by volume of the aqueous liquid, preferably between 5-30% by volume and most preferably between 10-15% by volume. For example, if one wishes to check whether the product to which the sensor has been attached has been exposed to a temperature above −5° C. (a typical temperature for storing frozen foods), one might want to use a solution of 12.3% ethyl alcohol 87.7% water.

The fracturable capsule ray further comprise an elastic element that facilitates the opening of the capsule. Advantageously the elastic element is a coil or a piece of curved plastic. The elastic element is advantageously employed when the concentration of the filly miscible liquid is high e.g. between 25-50% by volume of the aqueous liquid.

The elastic element is not capable of fracturing the fracturable capsule when it is intact. However when the aqueous solution expands upon freezing the fracturable capsule is ruptured. However when the aqueous solution contains a high proportion of misicible liquid the expansion may be insufficient to completely disassemble the fracturable capsule. However when the aqueous solution melts the elastic element has the capacity to disassemble the ruptured capsule to ensure that the aqueous liquid contacts the substrate.

The temperature sensor may be attached to the goods by any suitable method. Wherein the temperature sensor is located upon frozen foods the sensor is advantageously positioned inside transparent food packaging next to the product.

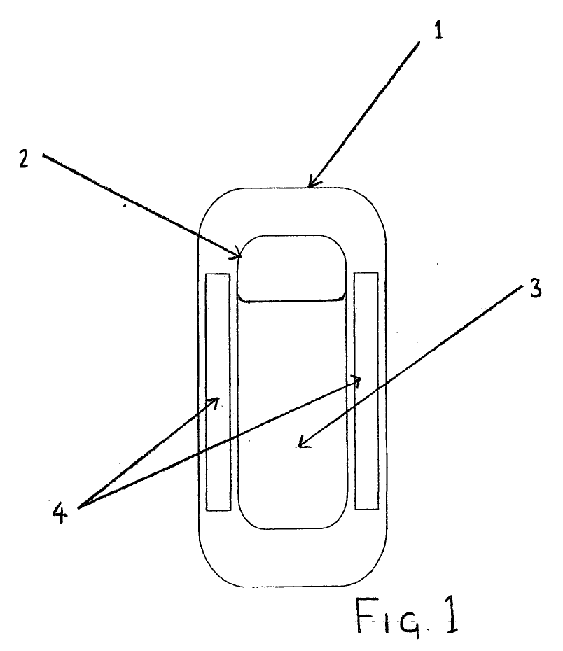

The invention will now be described with reference to FIG. 1.

FIG. 1 illustrates a temperature sensor according to the present invention comprising a transparent capsule (1) which contains a fracturable capsule (2) containing an aqueous liquid (3) which opens upon freezing of the aqueous liquid and a substrate (4) proximate to the fracturable capsule which exhibits a color change upon contact with the aqueous liquid.

Although the present invention has been fully described in connection with the preferred embodiments thereof, it is to be noted that various changes and modification are apparent to those skilled in the art. Such changes and modifications are to be understood as included within the scope of the present invention as defined by the appended claims unless they depart therefrom

What is claimed is:

1. A temperature sensor comprising a transparent capsule which contains an assembly within the transparent capsule wherein the assembly comprises:
a) a fracturable capsule containing an aqueous liquid which opens upon freezing of the aqueous liquid; and
b) a substrate proximate to the fracturable capsule which exhibits a color change upon contact with the aqueous liquid.

2. The temperature sensor as claimed in claim 1, wherein the aqueous liquid further comprises a coloring agent which is capable of staining the substrate.

3. The temperature sensor as claimed in claim 2, wherein the coloring agent is non-toxic.

4. The temperature sensor as claimed in claim 3, wherein the coloring agent is amaranth.

5. The temperature sensor as claimed in claim 1, wherein the substrate contains a coloring agent that changes color when contacted with the aqueous liquid.

6. The temperature sensor as claimed in claim 1, wherein the substrate is an absorbent substrate.

7. The temperature sensor as claimed in claim 1, wherein the substrate is a paper substrate.

8. The temperature sensor as claimed in claim 1, wherein the aqueous liquid comprises a fully miscible liquid.

9. The temperature sensor as claimed in claim 8, wherein the fully miscible liquid is an organic liquid.

10. The temperature sensor as claimed in claim 9, wherein the organic liquid is an alcohol.

11. The temperature sensor as claimed in claim 8, wherein aqueous liquid comprises 0 to 50% by volume of the fully miscible liquid.

12. The temperature sensor as claimed in claim 8, wherein the aqueous liquid comprises a particular concentration of the fully miscible liquid such that it freezes at a predetermined temperature.
